(19) United States
(12) Patent Application Publication
(10) Pub. No.: US 2026/0112225 A1
(43) Pub. Date: Apr. 23, 2026

(54) SYSTEMS AND METHODS FOR MACHINE LEARNING-BASED PHYSICAL CURRENCY CASSETTE REPLENISHMENT

(71) Applicant: HSBC Software Development (Guangdong) Limited, Guangdong (CN)

(72) Inventors: Motong QIAO, Hong Kong (CN); Hui CHEN, Xi An (CN); Cheung Yu LO, Hong Kong (CN); Huijuan LI, Guang Zhou (CN); Changlin GUO, Guang Zhou (CN); Chenguang LUO, Xi An (CN); Wei QIU, Guang Zhou (CN); Rui ZENG, Hong Kong (CN); Zongjie DENG, Guang Zhou (CN)

(21) Appl. No.: 19/424,700

(22) Filed: Dec. 18, 2025

(30) Foreign Application Priority Data
Dec. 30, 2024 (CN) 202411977454.4

(51) Int. Cl. G07D 11/245; G06N 20/20; G07D 11/12

(52) U.S. Cl. CPC G07D 11/245; G06N 20/20; G07D 11/12

(57) ABSTRACT

A specific architecture is proposed that utilizes two models being operated in parallel as an ensemble model approach based on Applicant's testing with physical machines. The ensemble model approach is provided as a physical system that operates two models simultaneously, both models being trained as candidate models. Both models are utilized during inference time separately to optimize a loss function (e.g., MAE performance), and during inference, the model with a superior MAE performance is used to control ATM replenishment control signal generation. The two models being used together include a first model, a fully connected neural network data architecture, and a second model, a tree-based learning algorithm provided as a gradient boosting framework (e.g., the Light Gradient-Boosting Machine, also known as the LightGBM). From a practical perspective, the ensemble models can be operated with a prediction buffer configured to allow for specific parameter tuning.

### CROSS-REFERENCE TO RELATED APPLICATIONS

The present application claims priority to Chinese Patent Application No. 202411977454.4, filed Dec. 30, 2024, the entire disclosure of which is hereby incorporated by reference in its entirety.

### FIELD

The present application relates to machine learning/artificial intelligence and more specifically, to systems and methods for machine learning-based physical currency cassette replenishment using physical sensor data and improved forecasting to control physical replenishment operations.

### INTRODUCTION

Managing the physical replenishment (replenishment includes both taking money out and placing money into) of currency cassettes has been an inefficient and inaccurate process, impacting the availability of currency in automated teller machines (ATMs). Manual forecasting approaches to predict cash demand for ATMs have been deficient as they have led to inaccurate cash level predictions that do accurately account for dynamic factors affecting cash deposit and withdrawal rates, such as seasonality, holidays, public events, and recent withdrawal trends.

This can result in ATMs either running out of cash, affecting customer service, or holding excess cash, which is not cost-effective. Accordingly, there have been unnecessary operating costs where ATMs required emergency refills or had to be serviced more often than necessary. This led to an increase in refill trips, escalating the costs associated with third-party cash delivery services. Without a responsive approach to changing cash demand, lead times on cash replenishment deliveries extending up to 36 hours can impact overall availability.

### SUMMARY

These challenges above have led to the development of an improved machine learning/artificial intelligence system that is configured as a specific solution for controlling physical cash replenishment. The improved approach provides a physical control tool that optimizes the cash distribution process to automated teller machines (ATMs), addressing the challenges of forecasting cash demand for ATMs. There are different types of machines, and while in this example ATMs are noted, there can be Cash Deposit Machines (CDMs), certain ATMs that can conduct both deposits and withdrawals acting as multi-function machines (MFMs), as well as multi-currency machines that are adapted for handling multiple currencies (e.g., a machine for use at an airport). An outage is defined when a user cannot interact with a machine because the cassette either has too many notes (e.g., can't deposit) or too few notes (e.g., can't withdraw). During an outage, an approach to mitigating is to submit a request for real-time replenishment, but an objective is to minimize the total number of real-time replenishments required so that the total number of trips can be minimized.

The physical control tool is coupled with a real-time ATM sensor feed, and sends control messages to logistics controllers and dispatch systems to control replenishment activities. The replenishment can be tracked in real-time in the ATM sensor feed, and in some embodiments, a specific route can be generated for a replenishment vehicle. An artificial intelligence/machine learning based system is proposed that tracks and analyzes live ATM data that is captured, for example, based on physical sensor inputs and a corpus of data obtained from physical interactions by users with ATMs. The inputs are processed using machine learning algorithms that are adapted to process factors including seasonality, holidays, public events, location, and recent withdrawal trends to accurately predict the amount of cash needed at each ATM. The use of machine learning allows for a more dynamic and responsive cash distribution strategy. The live data feed from ATMs can include physical sensor data, which is then processed to inform the predictive approach by updating a trained machine learning model with current withdrawal patterns.

A specific architecture is proposed that utilizes two models being operated in parallel as an ensemble model approach based on testing with physical machines. The ensemble model approach is provided as a physical system that operates two models simultaneously, both models being trained as candidate models. Both models are utilized during inference time separately to optimize a loss function (e.g., MAE performance), and during inference, the model with a superior MAE performance is used to control ATM replenishment control signal generation. The two models being used together include a first model, a fully connected neural network data architecture, and a second model, a tree-based learning algorithm provided as a gradient boosting framework (e.g., the Light Gradient-Boosting Machine, also known as the LightGBM). From a practical perspective, the ensemble models can be operated with a prediction buffer configured to allow for specific parameter tuning.

In operation, the prediction system can be configured to run periodically (e.g., nightly) to predict a cash deposit and generate a clearing order based on prediction data outputs, and the mini-batch data can be uploaded at a higher frequency (e.g., every 15 minutes), and the model prediction and re-training can be used to generate a cash clearing order that can be configured to control one or more cash-in-transit logistics operations. In a variation of the approach, instead of, or in addition to the graphical user interface, the artificial intelligence/machine learning based system is configured to generate machine outputs that directly control and provision cash replenishments of currency cassettes by generating and submitting logistics requests for currency replenishment.

The prediction system can be optimized for different usage and operation, such as to increase a cassette utilization percentage, reducing a total number of clearing trips, and/or reducing outage (and thus increasing service availability). The system can be configured for simultaneous operation against live production data as an automatic monitoring system that is able to run autonomously or semi-autonomously to control replenishment operations predictively.

In some embodiments, the generated replenishment control commands can be generated with entropy to modify path and operational timing by injecting noise to make cash-in-transit operations less vulnerable to physical attack by adding unpredictability. However, this noise injection will also reduce the tracking to optimal replenishment timing. As a physical output, a graphical user interface, such as a dashboard, can be rendered to visualize live withdrawal patterns, enabling a user to make informed decisions and respond quickly to cash demand. In application, this approach was found to reduce cash replenishment lead times from up to 36 hours down to just 15 minutes.

In some embodiments, there may be a plurality of ATM groups where multiple ATMs at a particular location can be selectively replenished. In each ATM group (e.g., five ATMs) in a same location serving customers exiting an entrance of a stadium. If an ATM is out of physical notes, a user may simply utilize another ATM that has notes. In this variation, every ATM of each ATM is considered to be a member of a group where an outage is only tracked when a total of all of the ATMs in the group has decreased below a threshold of notes or other dispensed physical objects.

The foregoing has outlined the features and technical advantages in order that the detailed description that follows may be better understood. Additional features and advantages will be described hereinafter. It should be appreciated by those skilled in the art that the conception and specific embodiment disclosed may be readily utilized as a basis for modifying or designing other structures. It should also be realized by those skilled in the art that such equivalent constructions do not depart from the spirit and scope of the embodiments described herein. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the embodiments described herein.

### BRIEF DESCRIPTION OF FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a block schematic of an example model architecture and system for machine learning-based physical currency cassette replenishment, according to some embodiments.

FIG. 2 is a logic flow diagram of a model selection approach and an example feature list for both models that are used together in concert, according to some embodiments.

FIG. 3 is an example data flow diagram showing an end to end approach for both data flow and model feedback flow, according to some embodiments.

FIG. 4 shows an example logic flow that is utilized to illustrate cash replenishment logic, according to some embodiments.

FIG. 5 is an example cash order that can be generated by the proposed system, according to some embodiments.

FIG. 6 is an example table showing experimental outputs during operation of the approach under a set of different buffer amounts, and compared against a baseline reference model, according to some embodiments.

FIG. 7 is an example graph of cash deposit data, according to some embodiments.

FIG. 8 is an example graph showing cash deposits showing a latent periodicity, according to some embodiments.

FIG. 9 is an example illustration of an example fully connected neural network, according to some embodiments.

FIG. 10 is an example screenshot showing example code for implementing the system, according to some embodiments.

FIG. 11 is an example illustration of a gradient boosting framework using tree-based algorithms and leaf-based approaches, according to some embodiments.

FIG. 12 is an example connected graph diagram showing an example LightGBM intermediate trained graph, according to some embodiments.

FIG. 13 is an example graph showing example CDM level deposit patterns, according to some embodiments.

FIG. 14 is an example diagram showing feature importance values generated using the ARIMA model, according to some embodiments.

FIG. 15 is a comparison graph showing example cash deposit against predictions, according to some embodiments.

FIG. 16 is an example chart mapping CDM performance against a total number of size outages, according to some embodiments.

FIG. 17 is an example multi-ATM site where each ATM machine has different cassettes and amounts of money stored in them, according to some embodiments.

FIG. 18 is an example chart mapping replenish amount against the number of days in a specified time period, according to some embodiments.

FIG. 19 shows example charts mapping the optimal replenishment amount against total cost and interest rates, according to some embodiments.

FIG. 20 is an example chart displaying the cash availability and total cost in each for when the refined experimental object is expanded to all remote ATM experimental data for one year, according to some embodiments.

FIG. 21 is an example user interface for a simulation feature enabling users to optimize cash replenishment strategies for the machines, according to some embodiments.

### DETAILED DESCRIPTION

An improved machine learning/artificial intelligence system and corresponding methods is proposed for controlling physical cash replenishment. The improved machine learning/artificial intelligence system is an ensemble model data architecture that utilizes two machine learning model data architectures that are trained and run in inference in parallel that are both utilized to generate predictive outputs optimized based on a mean absolute error performance score (MAE). During testing, it was found that using an ensemble model approach yielded improved results as the diverse characteristics of the models could be utilized as different physical automated teller machines (ATMs) appeared to map better to different model data architectures. During experimentation, it was found that the proposed approaches yielded significant improvements relative to reference baseline approaches using rule-based logic, formulated as an optimization problem for which the goal is to decide when a clearing order should be imposed based on the time series prediction of the cash deposit amount in the next days.

The system includes an ATM controller that is coupled to a plurality of ATMs at different locations that report sensory information through live ATM feeds based on physical sensors that are coupled to physical cash cassettes. The data can include data objects, such as JSON files or XML files that are structured with fields, including fields such as the Term ID of each CDM, CDM site locations and mapping to each CDM term ID, Capacity of each cassette in each CDM (i.e. maximum number of banknotes in each cassette), Historical CDM cash balance for each CDM in every 15 minutes, Historical cash order for each clearing trip for each CDM, Historical cassette utilization percentage whenever making a clearing to a CDM.

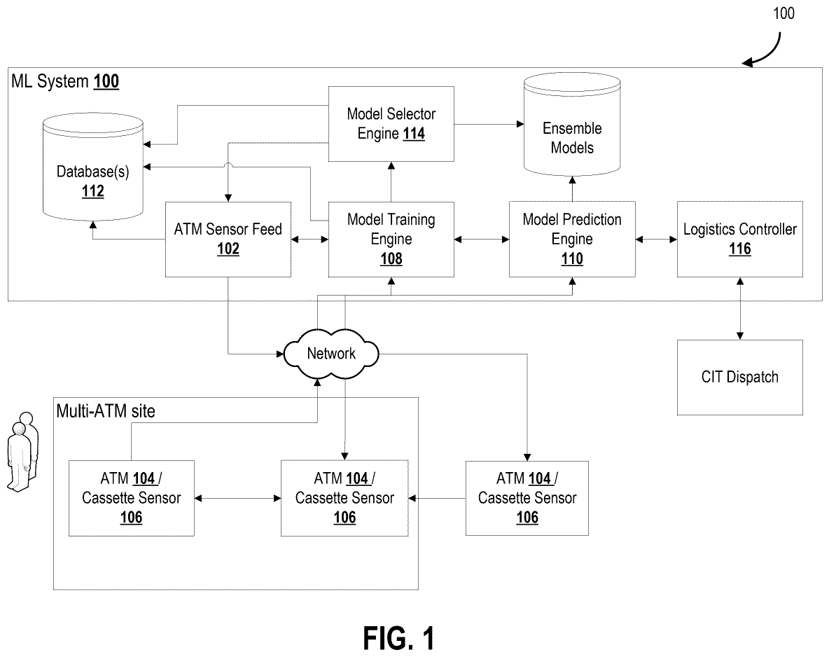

FIG. 1 is a block schematic of an example model architecture and system for machine learning-based physical currency cassette replenishment, according to some embodiments. In FIG. 1, a system 100 is proposed that is a physical control server that is configured to operate in a data center, coupled with a real-time ATM sensor feed 102 from physical ATM sensors that can be coupled to individual ATM 104 currency note cassettes 106 at to measure available volume (e.g., by measuring spring forces, a size of a cavity) to estimate a number of notes in the cassettes 106. The real-time ATM sensor feed 102 can thus be representative, at a given point in time, of the current state of currency note holdings at any ATM cassette 106. The real-time ATM sensor feed 102 can be scheduled for electronic communication by periodic polling to obtain data sets for training/inference, or in other embodiments, for push based communications based on a request message transmitted on an interrupt signal.

These are processed and provided to as inputs into a machine learning model, and can include information in variables such as those shown in Table 1, below.

TABLE 1

| Variable | Rationale for Inclusion |
|---|---|
| Cash deposit data | Past data for the predicted values (Cash Deposit) |
| Time Based Variables | Information related to the prediction date (month, |
| | day of month, week, day of week, weekend, etc.) |
| Holidays Calendar | Holidays may affect Cash deposit pattern |
| Horse Racing Calendar | Horse racing schedule may affect Cash deposit |
| | pattern |
| Spring Festival data | Features created for the Spring Festival period |

The system 100 includes a model training engine 108, a model prediction engine 110, and a data storage 112 that maintains the predicted model weights and filter parameters of an ensemble model having at least a first model and a second model that are operated together. A model selector 114 is configured to control which model outputs are utilized and provided by the model prediction engine 110 to generate logistics control messages to logistics controller 116, which is coupled to dispatch systems to control replenishment activities. The logistics controller 116, in some embodiments, can be configured to generate cash delivery or cash pickup orders, and in other embodiments, is configured also or instead to generate paths for cash delivery or cash pickup. The logistics controller 116 can be coupled by way of a dispatch system to one or more cash-in-transit vehicles to issue instruction sets and/or to generate specific paths and waypoints for cash delivery or pick up, as required. The replenishment can be tracked in real-time in the ATM sensor feed, and in some embodiments, a specific route can be generated for a replenishment vehicle. The ML System 100 is configured for generating a predictive output, which is the predicted cash withdrawal/deposit for the next duration (e.g., next X hours). Based on the predicted value and the current cash balance, the system 100 is then configured to generate cash order generation to calculate the cash balance for the next duration, and the logistics controller 116 is configured to generate CIT orders to modify the cash balances to have sufficient holdings (for an ATM) or space (for a cash deposit machine) on the corresponding cassettes. In some embodiments, the logistics controller 116 operates to control individual notes cassettes for specific types of banknotes.

The logistics controller 116 controls CIT trips to be dispatched in accordance with a schedule, ideally during a replenishment run during off hours that provides enough capability to handle all of the transactions during a period. Each visit to an ATM site is counted for the purposes of tracking a total number of trips and can be assigned a cost for model reward/penalization. For the model, an objective function is to optimize the MAE for the cash withdrawal, tuning the model, the cash order logic, and cassette configurations to control an tune outage level against a number of CIT trips, and in some embodiments, these are configurable options that an administrator can use to define which threshold and configuration to be the best option. In another embodiment, the ML systems are configured only to reward/penalize based on an error term against the actual deposits/withdrawals only, and that information is used to control dispatch capabilities.

Where the expected requirements are beyond the physical capabilities of an existing cassette, in some embodiments, the logistics controller 116 is configured to pre-emptively control for an unscheduled replenishment trip.

The aim of the time series prediction model is to predict the cash deposit amount in the next few days so that corresponding cash clearing orders can be recommended to make the clearing trips at the right time.

The model 110 is set by a scheduler to run daily at 00:00 to predict the cash deposit and generate the clearing order based on the prediction result. The schedulers upload the mini-batch data every 15 minutes, trigger the model prediction, trigger the model retraining, etc. The model training engine 108 is used for updating a model, and the model prediction engine 110 generates the estimated deposit/withdrawal activity information. This is an output that is provided to a downstream cash clearing order generation module to automatically generate the cash order based on the model prediction results, and a cycle report generation module is utilized to automatically calculate the performance metrics and summarize them into a report in a monthly and weekly manner.

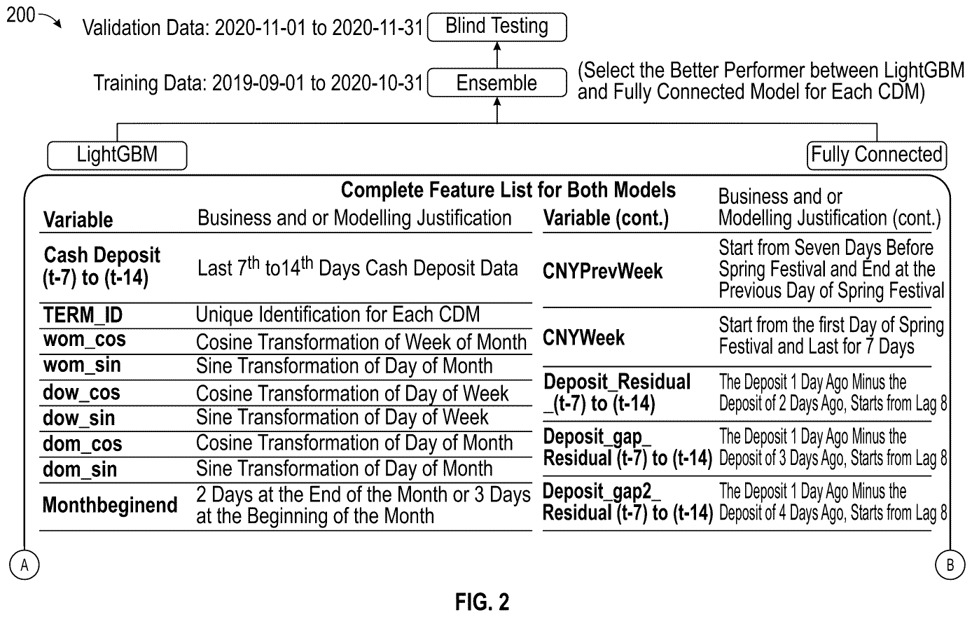

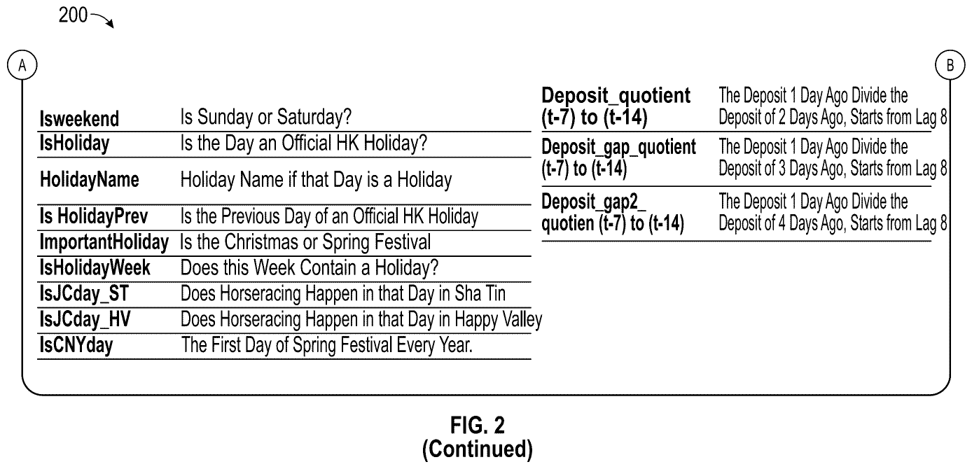

As noted herein at FIG. 2, a logic flow is summarized in FIG. 2 showing how the machine learning prediction engine 110 operates as a time series prediction module, an ensemble model based on LightGBM and fully connected neural network is employed for modeling time series data. The program adopts either a LightGBM model or a fully connected neural network model for each CDM, whichever yields a lower prediction error. In time series prediction, the future variance and average value are assumed to be similar to the training data. However, this assumption may not stand after the occurrence of an unexpected event. This model risk is mitigated by enabling users to configure the prediction buffer. In case of a sudden change in deposit due to external circumstances (E.g., COVID), the user would adjust the buffer and prevent outages from happening. The operation team assesses the model based on the business metrics in weekly and monthly cycle reports, including overall service availability, total outage hour, cassette utilization percentage, and the number of CIT trips. The development team will retrain the model once the model performance is considered unsatisfactory. The model is reviewed by the business sponsor and further examined in the panel review meeting. It is confirmed that the model complies with the rule and guideline defined in the FIM. There are no specific external compliance and regulatory requirements on the model. The model can be optimized by adding or removing specific features and using ensemble models in production. The model can be enhanced by adding features such as replenishing window, cost of cash, etc.

The model output of FIG. 2 can include the following:

### Predicted Cash Deposit

The output of the time series prediction model is the cash deposit for all CDM in the coming eight days. The predicted cash deposit amount is used to decide whether a clearing trip is required for a particular CDM.

### Cash Order Report

The cash order result is further adjusted by the configuration and manual logic defined by the users in the cash order generation module. The module output is a cash order that the business user can send to the vendor for conducting cash clearing. A sample cash order is shown below.

### Cycle Report

The cycle report summarizes model performance in terms of the business metrics defined by the users. The business users evaluate the model based on the result in the cycle report. The program generates a weekly cycle report every weekend and a monthly cycle report at the end of the month. A sample of the cycle report is shown below.

FIG. 2 is a simplified diagram showing a model selection approach and an example feature list for both models that are used together in concert.

As shown at 200, the ensemble approach is used to select the better performer for each CDM transaction, and thus both models are being used at the same time so that the architecture is able to leverage the diverse characteristics of both models during each inference generation.

During the determination of the model methodology, the first step during model selection was to attempt several potential models. Applicants did not try the Linear Regression and Exponential Smoothing models because they are sensitive to outliers. In the cash deposit data, it was anticipated to have a large amounts of spikes which the model was designed to predict as close as possible.

During experimentation of different model architectures, it was found that the LightGBM model and Fully Connected Neural Network outperform SARIMA and other linear model in terms of prediction error so Applicants skipped the SARIMA model as well. Therefore, the attempted models at first stage include a LightGBM, and Fully Connected Neural Network model. Applicants then conducted performance analysis and model selection. The overall model selection process contains two phases:
1. Model selection using statistical evaluation metrics
2. Validation with Business performance metrics

During experimentation, different approaches were used (MAE, MSE, RMSE, MAPE and R2) to identify the configuration for each model first. Then the approach included validating the forecast results using business performance metrics in simulation experiments. Based on the results of these two phases, the proposed model was selected.

Both the LightGBM and Fully Connected model are very efficient as they use only one model to predict for all CDMs. When Applicants further investigate the model performance, it was found that for some machines, LightGBM performs better while for others, a Fully Connected model will provide a more solid prediction.

In summary, an ensemble model of a LightGBM model and Fully-connected Neural Network model is the preferred model, since it not only has the best statistical performance, but also has great efficiency. The model performance is benchmarked against the current rule-based logic for CDM clearing. Therefore, no challenger model is needed in this use case.

From the analysis, it was found that the deposit patterns on holidays and holiday eves are different from the usual cash deposit patterns. And for important holidays, including Spring Festival and Christmas, the pattern is more differentiated (some peaks or troughs occurred). Therefore, these features were selected to have the model perform better during holiday periods so as to reduce outages.

A fully connected neural network consists of a series of fully connected layers. Each output dimension depends on each input dimension. To prevent overfitting, Applicants used a 0.75, 0.25 random split for training and validation of the dataset. The Neural Network Framework started from a three rectified linear unit (ReLU) layer basic network and after several experiments, Applicants added one sigmoid layer. Applicants utilized a reduce-increase-reduce framework similar to convolutional neural networks to choose the number of nodes in each layer. The consideration behind this network is to encode then decode to avoid too much information loss then encode again. Higher learning rates were possible because batch normalization makes sure that there's no activation that has gone high or low. And by that, things that previously could not get to train, it will start to train. It reduces overfitting because it has a slight regularization effect. Like dropout, it adds some noise to each hidden layer's activations. Therefore, if one uses batch normalization, one will use less dropout, which is a technically beneficial as the approach helps reduce loss of information.

The value 0.1 was used as dropout to some of the layers. Additionally, early stopping and a specified number of epochs are applied to find the point when the model converges and to avoid overfitting. Designing the FC model with ReLU function in output layer ensures that any prediction is larger than 0. The ReLU layer also avoids and rectifies vanishing gradient problem.

The reason Applicants utilized MAE as the loss function rather than RMSE and MAPE is that RMSE gives too high of a penalty for extreme points (special event driven) and that it is not stable enough in the normal period, while MAPE is not a good estimator of error when the actual value is very big. In other word, it gives high penalty for a bad prediction when the actual cash deposit is low but does not give enough penalty for a bad prediction when the actual cash deposit is high. For MAE, in a proposed approach, Applicants optimized the absolute value of the difference between prediction and actual cash deposit. All of the machines are trained with one model so the loss function will give higher penalty for those machines with higher cash deposit volume.

LightGBM is a gradient boosting framework that uses tree-based algorithms and follows leaf-wise approach while other algorithms work in a level-wise approach pattern. It is designed to have faster training speed and higher efficiency. It beats all the other algorithms when the dataset is extremely large. Compared to other algorithms, LightGBM takes less time to run on a huge dataset. Therefore, LightGBM is efficient in this scenario since Applicants trained one model for all machines.

With a number of parameters for the model, Applicants applied gridsearch to tune the hyperparameters and finally selected a learning rate of 0.15, number of iterations of 2400, number of estimators as 150, and max depth as 17. Applicants also selected the feature fraction to be 0.8, which means LightGBM will select 80% of parameters randomly in each iteration for building trees. The combination of this learning rate, tree infrastructure, and feature fraction will improve accuracy while avoiding overfitting at the same time.

Since Applicants found some machines perform better with LightGBM while others perform better with the Fully Connected Neural Network, Applicants have proposed an ensemble model based on the best MAE performance for both models, such that both models can be trained and maintained deliberately, until the model with less run time is chosen. When the code for the models are being executed on the computer's CPU as machine code, MAE is applied here not only to keep consistency with loss function for both models, but also to penalize machines with higher deposit values which are likely to cause serious outage problems more. Ensemble modeling is a process where multiple diverse base models (e.g., LightGBM and FCNN in this approach) are used to predict an outcome. Ensemble models can be used to reduce generalization error of the result by merging predictions of the different models. Using ensemble models not only enhances accuracy but also provides resilience against uncertainties in the data.

Applicants used prediction result of the FC and LightGBM from 2019 August to 2020 October as ensemble training period and calculated the MAE of these two models based on each term_id and picked the lower MAE model for that term id. After selection, Applicants had a list of terms and the corresponding model for that term.

LightGBM and FCNN were selected as the ensemble modelling approaches after an initial exploration over several modeling approaches, namely ARIMA/SARIMA, LightGBM, XGBoost, Catboost, and fully connected neural networks (FCNN). The modelling approaches were tested on the same training and test sets with the same set of features.

TABLE 2
displays the results of the tests for a randomly selected 500 machines,
showing a practical experiment of the various types of models.

| Model Name | RMSE | MAE | Training Time(minutes) |
|---|---|---|---|
| LightGBM | 118911 | 77419 | 96 |
| LinearRegressor | 132438 | 90050 | 46 |
| RandomForestRegressor | 133078 | 89655 | 282 |
| XGBRegressor | 121490 | 79466 | 185 |
| Keras Neural Network | 120149 | 77303 | 202 |

The LightGBM and FCNN models had the best performance in terms of MAE and were therefore selected as the ensemble models. For ARIMA/SARIMA, it is hard to maintain the model repository (since there is one model per machine) and it is slow to train them separately, and the model performance is unsatisfactory. When testing LightGBM/XGboost/Catboost, LightGBM requires the least resources to train and provides the fastest training speed. The test dataset has thousands of machines, so training using XGboost requires a GPU. There were no significant improvements when using Catboost with high-dimensional categorical features (Geolocation/Machine ID). So, for tree-based models, LightGBM was selected as only one model needed to be trained for all machine time series, being simple to manage. Furthermore, the model does not need to be frequently retrained. Fully connected feed-forward neural network models require less resources to build and tune. Other neural network architectures (such as RNN-based models) could be potentially used, but that would require a more extensive investigation of architecture and hyperparameters.

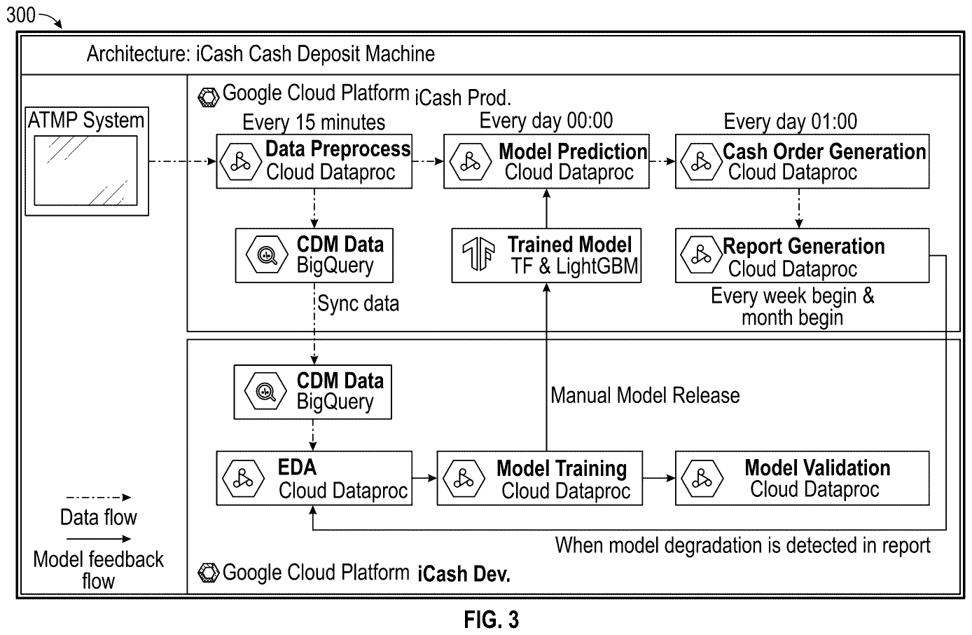

FIG. 3 is an example data flow diagram showing an end to end approach for both data flow and model feedback flow, according to some embodiments. As shown at 300, different periodicities can be conducted for different types of query and training. In this example, training can be conducted in real-time.

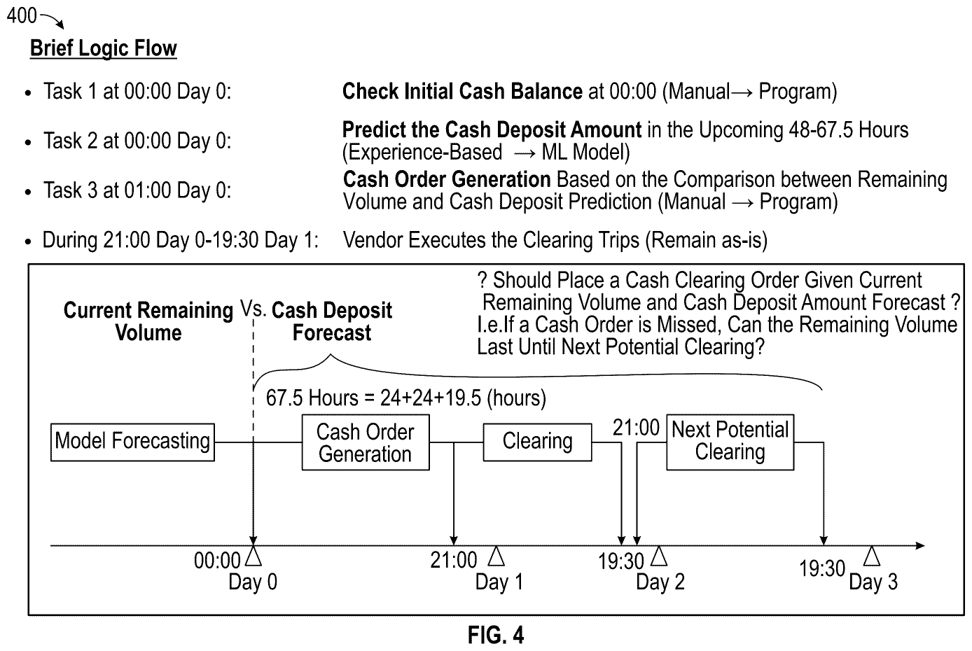

FIG. 4 shows an example logic flow that is utilized to illustrate cash replenishment logic, according to some embodiments.

In the logic flow of 400, the periodic approach of FIG. 3 is utilized to control the operation at different time cycles, and an approach is shown for both cash order generation and controlling clearing operations, based on a combination of remaining volume and cash deposit amount forecasts.

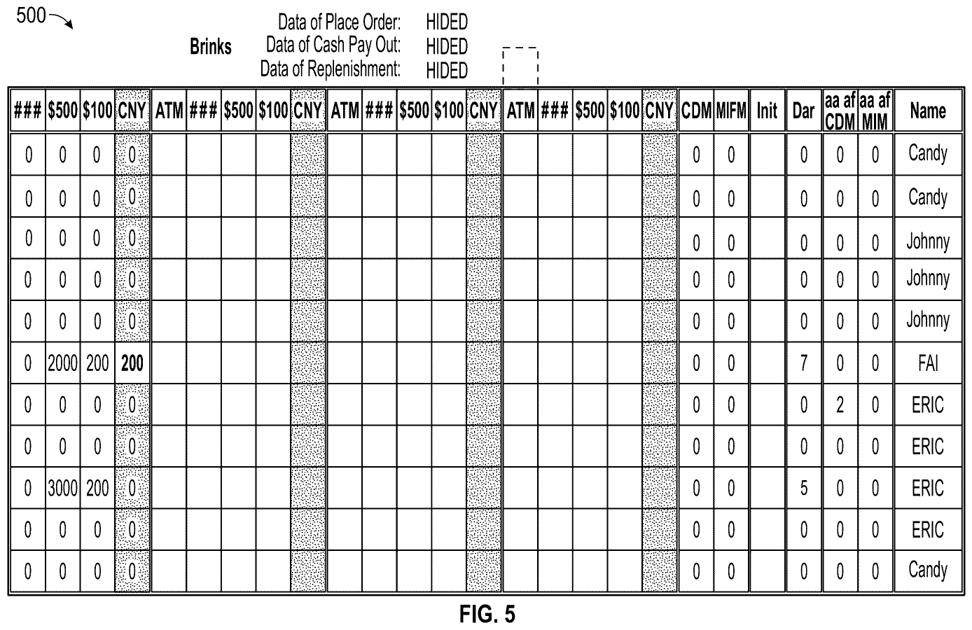

FIG. 5 is an example cash order that can be generated by the system, according to some embodiments. In the cash order 500, the specific list of ATMs requiring replenishment are noted, along with specific amounts required for different currency notes and denominations.

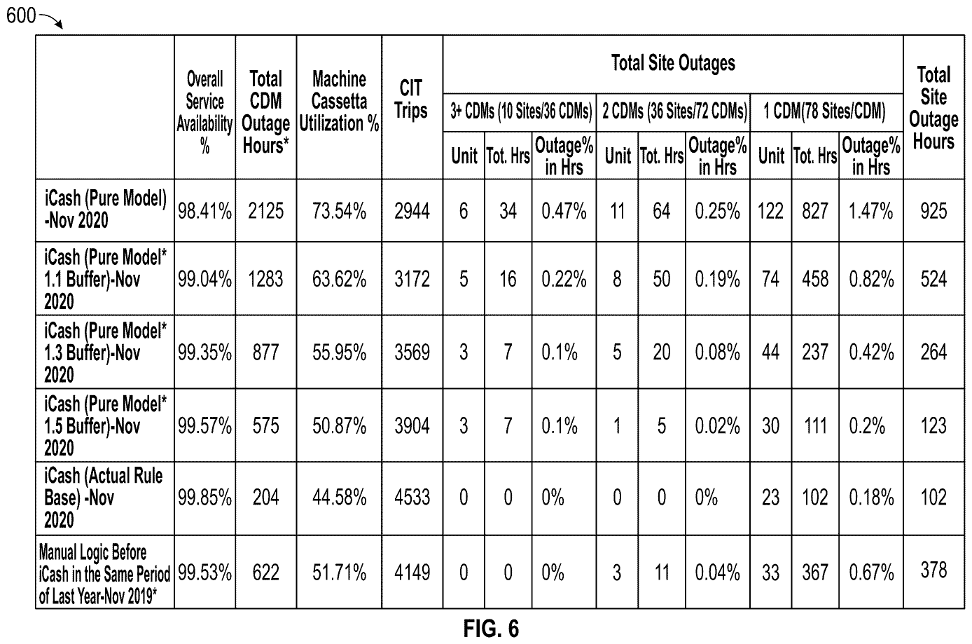

FIG. 6 is an example table showing experimental outputs during operation of the approach under a set of different buffer amounts, and compared against a baseline reference model. As shown table 600, it is clear that the machine cassette utilization and the total number of CIT trips has been reduced relative to baseline. However, as between different buffer amounts using the ensemble model data architecture, it can be observed that optimizing for machine cassette utilization percentage or reducing a total number of CIT trips also had a corresponding effect on reducing service availability percentage, also impacting a total number of outage hours.

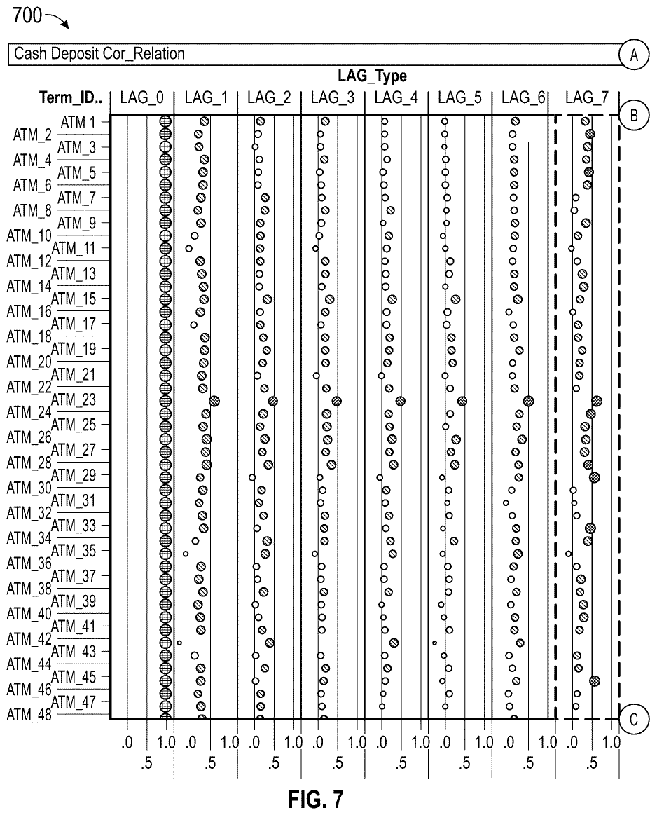

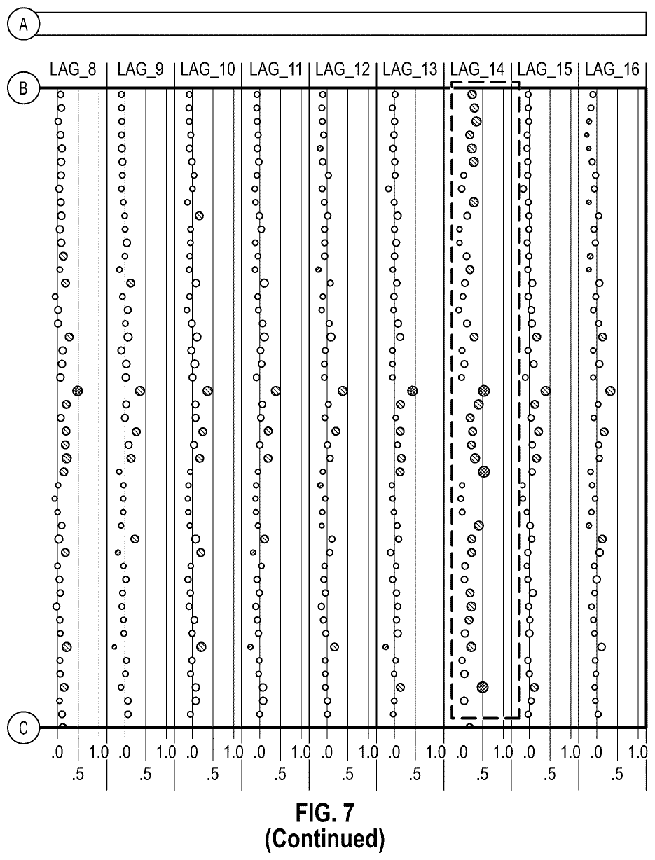

FIG. 7 is an example graph of cash deposit data, according to some embodiments. In graph 700, latent patterns begin to emerge in the ATM feed data coupled with external data, such as weather, sporting events, indicating a latent seasonality that may be somewhat irregular. The seasonality may be difficult for a human to conceptualize given that the periodicity may be non-linearly related and further may include entropy or differences in routine, etc.

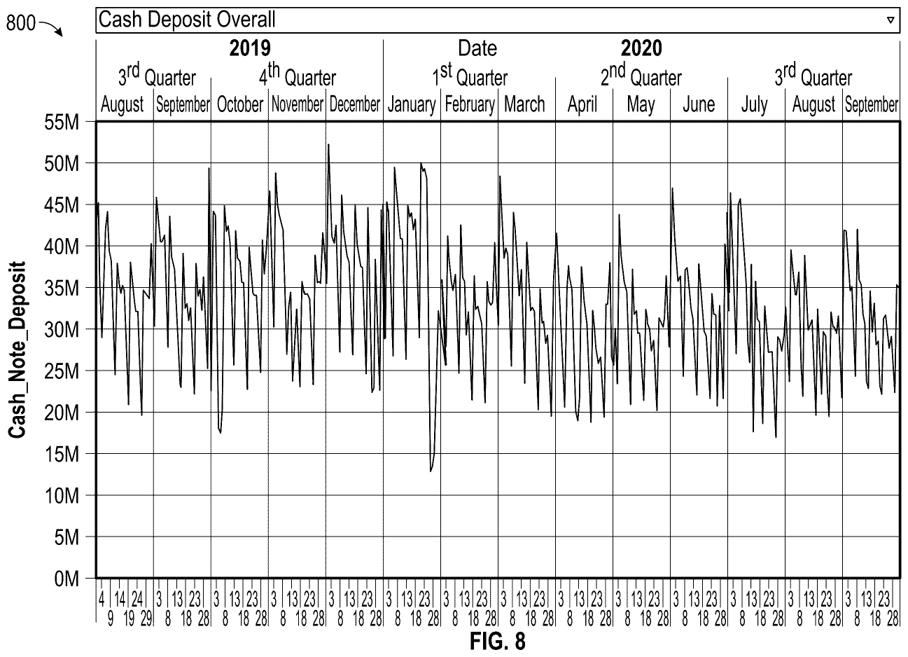

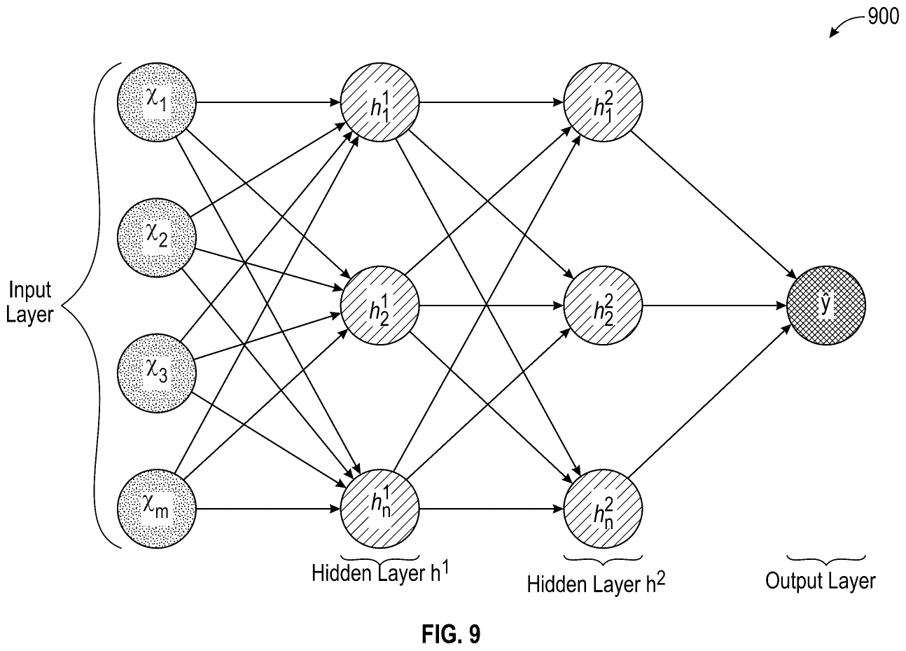

FIG. 8 is an example graph showing cash deposits showing a latent periodicity, according to some embodiments.

FIG. 9 is an example illustration of an example fully connected neural network, according to some embodiments.

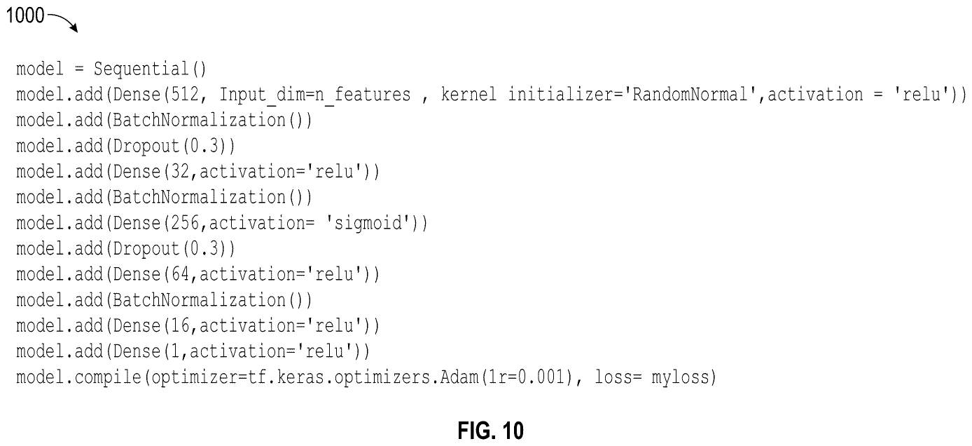

FIG. 10 is an example screenshot showing example code for implementing the system, according to some embodiments.

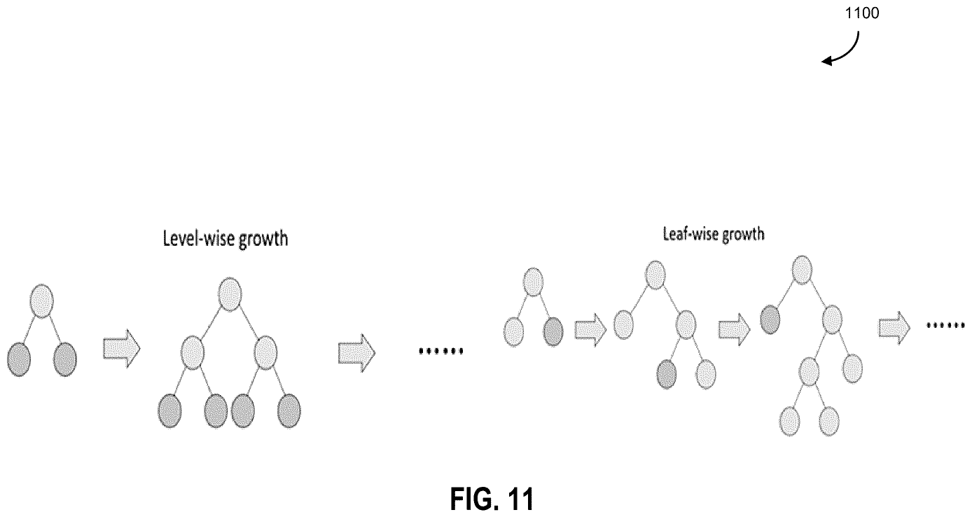

FIG. 11 is an example illustration of a gradient boosting framework using tree-based algorithms and leaf-based approaches, according to some embodiments.

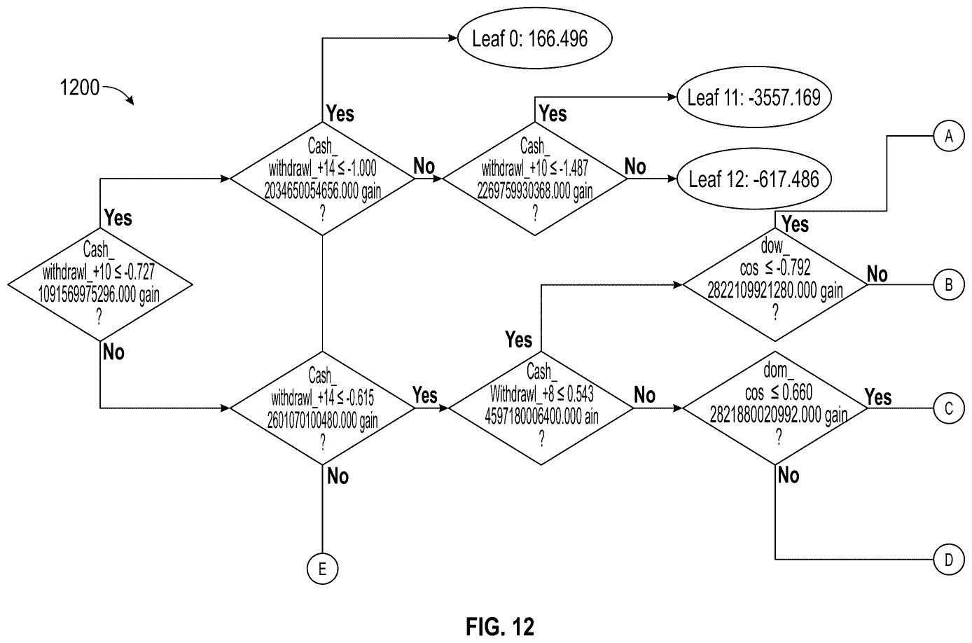

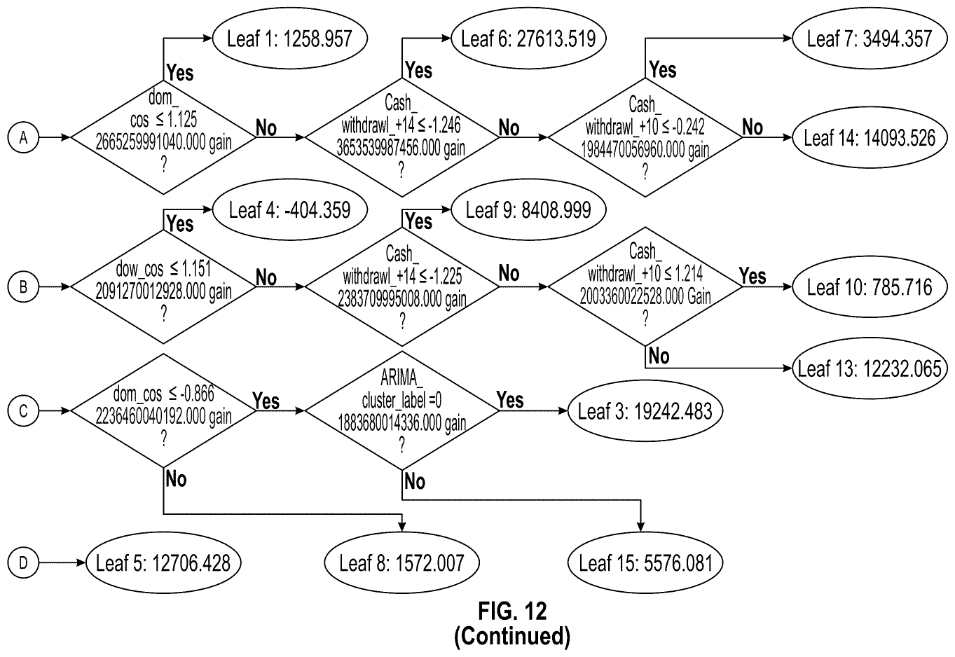

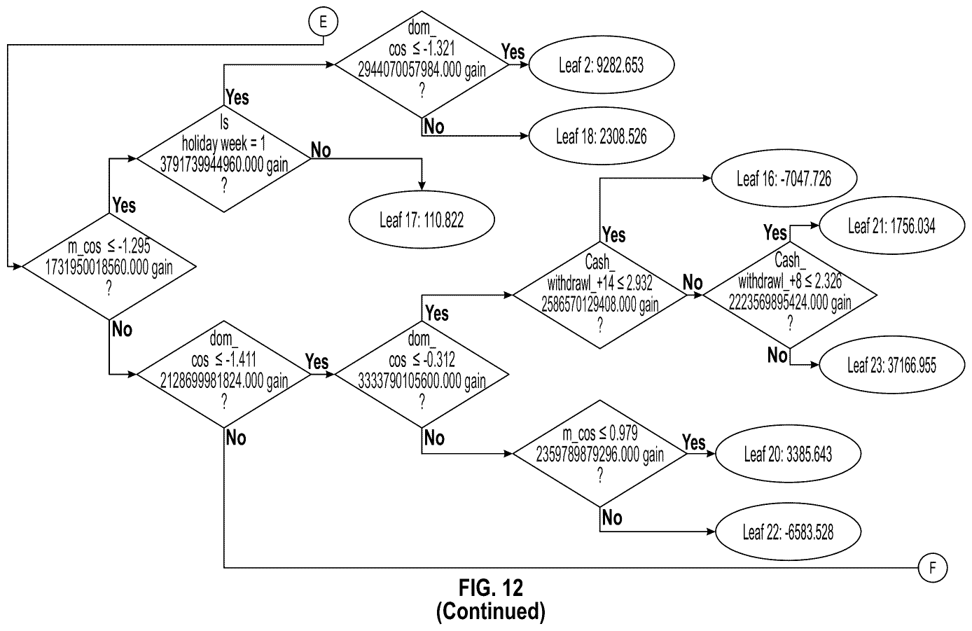

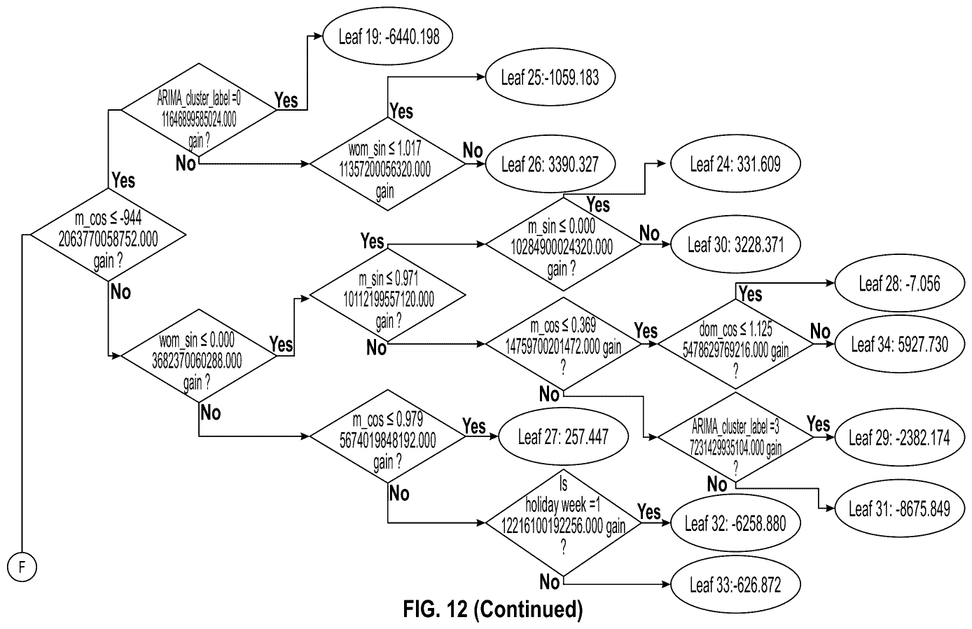

FIG. 12 is an example connected graph diagram showing an example LightGBM intermediate trained graph, according to some embodiments.

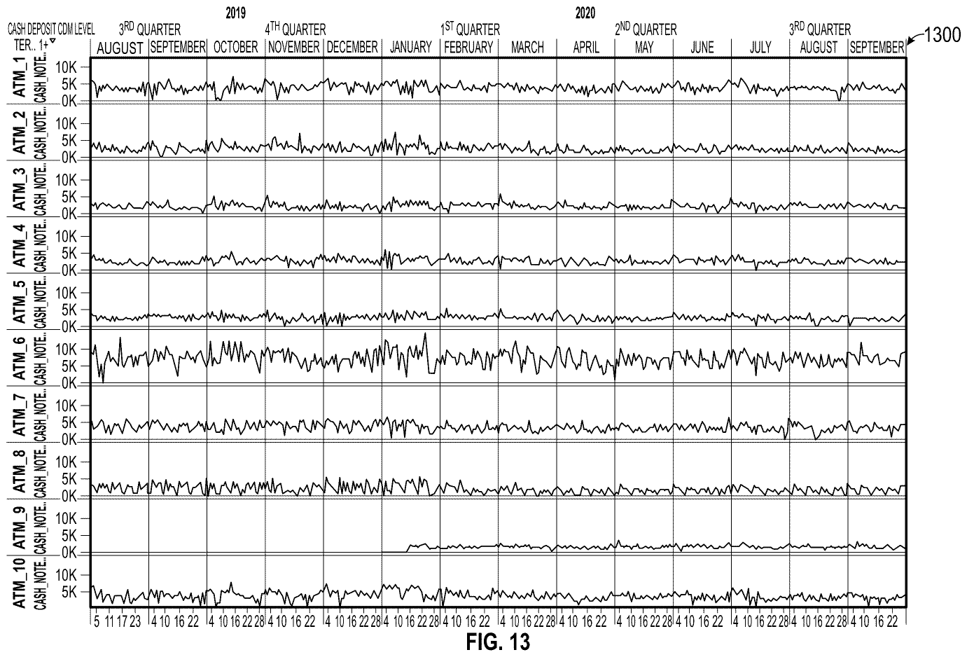

FIG. 13 is an example graph showing example CDM level deposit patterns, according to some embodiments.

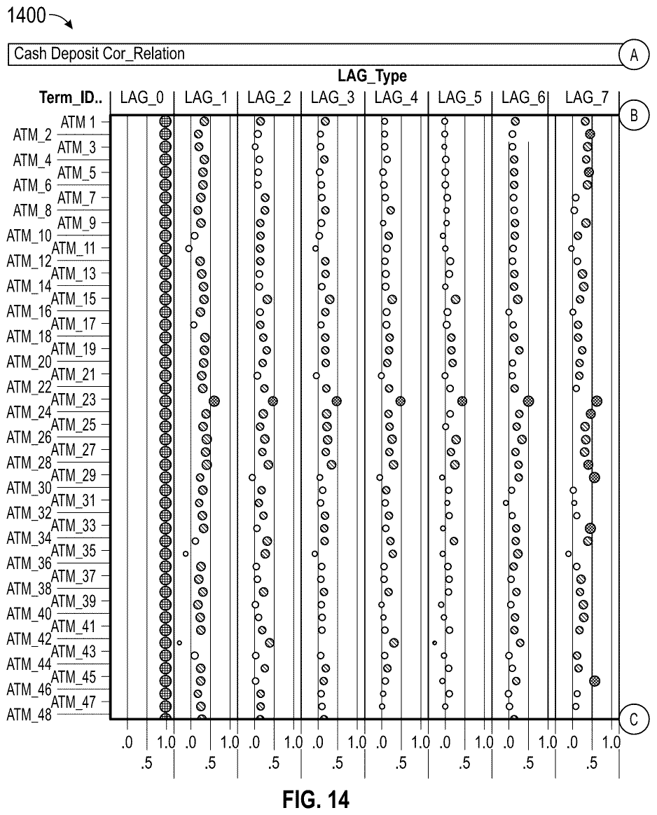

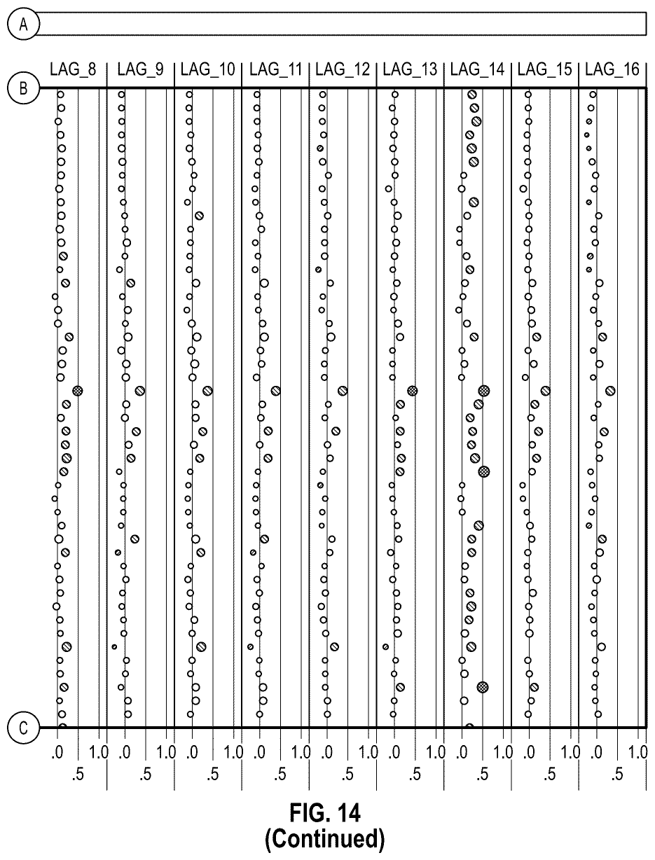

FIG. 14 is an example diagram showing feature importance values generated using the ARIMA model, according to some embodiments.

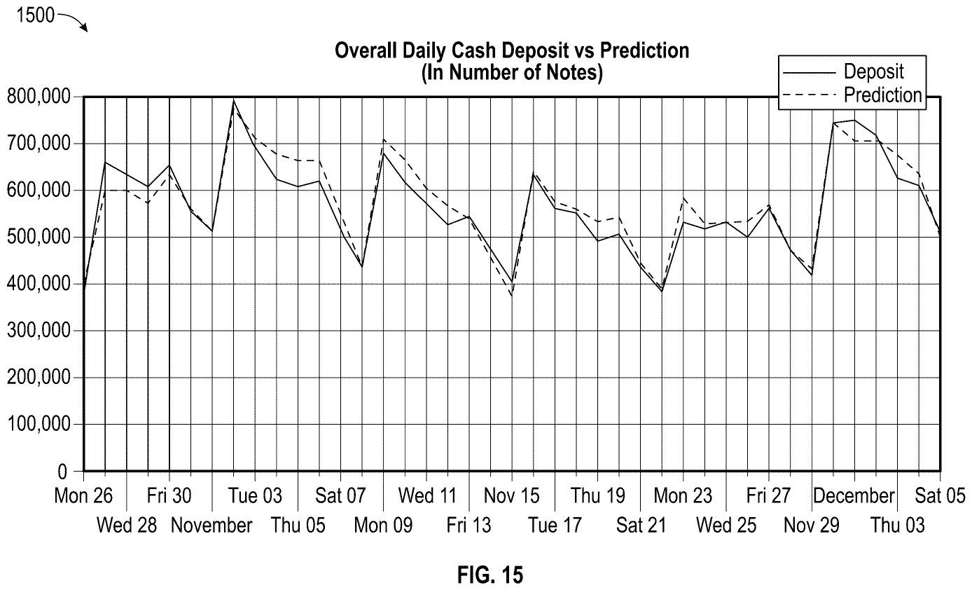

FIG. 15 is a comparison graph showing example cash deposit against predictions, according to some embodiments.

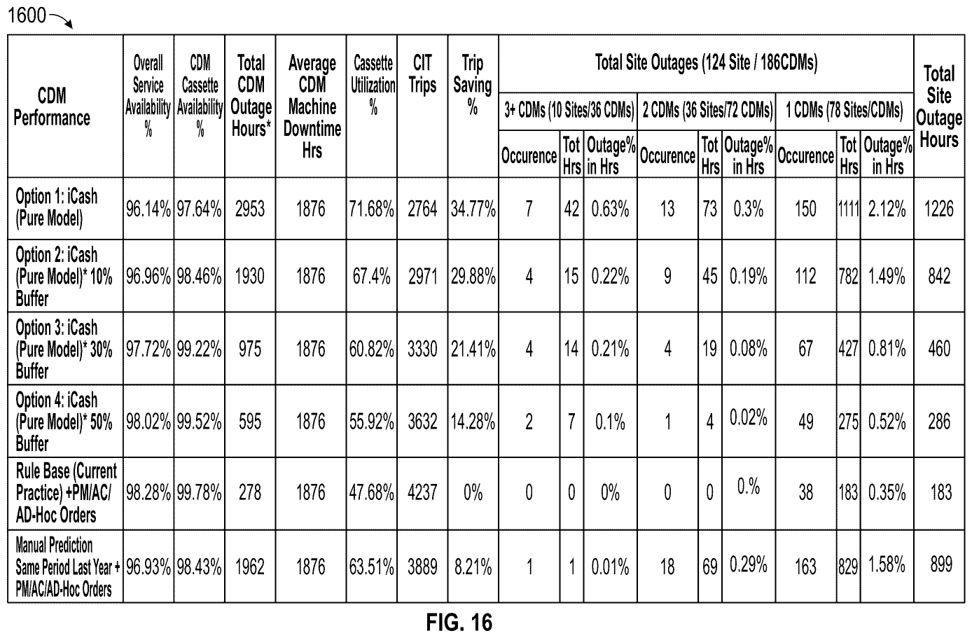

FIG. 16 is an example chart mapping CDM performance against a total number of size outages, according to some embodiments.

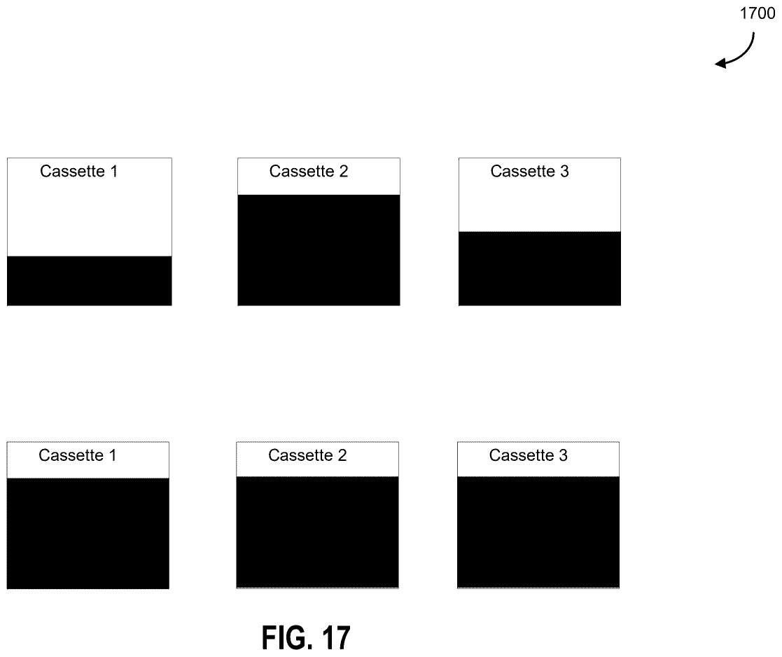

FIG. 17 is an example multi-ATM site where each ATM machine has different cassettes and amounts of money stored in them, according to some embodiments.

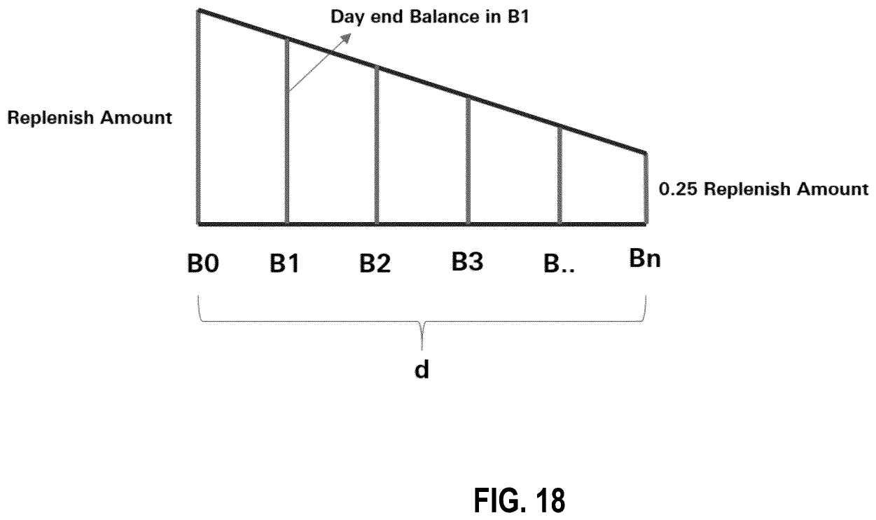

FIG. 18 is an example chart mapping replenish amount against the number of days in a specified time period, according to some embodiments.

As the interest rate increases, there is a large amount of opportunity cost for money held in ATMs. The higher the interest rate becomes, the higher the cost of cash becomes. However, the cost of ATMs comes mainly from two sources: vendor's costs and interest. A key variable that affects both vendor's cost and interest cost (cost of cash) is the replenishment amount as it affects the number of trips and day-end balances. To lower the cost of cash, the optimal amount of replenishment can be determined with respect to a given interest rate.

As seen in FIG. 18, the replenishment amount can be modelled with two assumptions. The first assumption is that the residual cash is 25% of the replenishment amount. This assumption can be modelled using the following equation:

$${R}_{T} = p * {R}_{T} + {W}_{T} = R * N \qquad ( 1 )$$

The second assumption is that the withdrawal amount is the same every day, meaning a constant rate of decrease in the balance every day. This assumption can be modelled using the following equation:

$$d = \frac{{D}_{T}}{N} \qquad ( 2 )$$

The B₀, B₁, . . . , Bₙ represent the day-end balance of each of the days, and d represents the frequency of the trips. D_{T} represents the number of days in the specified time period, N represents the number of trips in D_{T}, W_{T} represents the total withdrawal in D_{T}, R_{T} represents the total replenishment in D_{T}, R represents the replenishment amounts each time and P represents the residual cash rate (which is assumed to be 25%).

The total cost depends on the cost of the vendor and cost of interest, as expressed in the following relationship:

$${C}_{T} = N * ( {C}_{V} + {C}_{I} ) \qquad ( 3 )$$

wherein C_{V} represents the cost of the vendor and C_{I} represents the cost of interest.

The cost of the vendor C_{V} for one trip can be represented using the following equation:

$${C}_{V} = ( {C}_{b} + {C}_{{r}_{1}} * \frac{max ( R - {b}_{1} , 0 )}{{b}_{2}} + {C}_{{r}_{2}} * s ) \qquad ( 4 )$$

C_{b} is the base cost per trip, which can be $751.80 as an example. Cᵣ_{₁} is the cost rate of the excess of R over 700,000 in thousands. For example, for b₁=700,000 and b₂=1,000, Cᵣ_{₁} would have a value of 0.61. s represents the distance of a trip and Cᵣ_{₂} is the cost rate of s, which can be 10.86, for example.

The cost of interest between trips can be represented using the following equation:

$${C}_{I} = {\sum }_{j = 0}^{d - 1} {B}_{j} * {i}_{d} \qquad ( 5 )$$

with the following conditions:

$${B}_{0} = R \qquad ( 6 )$$

$${B}_{d} = p * R$$

$${B}_{j + 1} = {B}_{j} - W$$

$${i}_{d} = \frac{{i}_{y}}{365}$$

wherein Bⱼ represents the jth day-end balance in between trips, W is the daily withdrawal, i_{d} represents the daily interest rate, and i_{y} is the yearly interest rate.

The target cost function with respect to replenishment and yearly interest rate is:

$$f ( R , {i}_{y} ) = \frac{{W}_{T}}{( ( 1 - p ) * R )} * ( {C}_{b} + {C}_{{r}_{1}} * \frac{max ( R - {b}_{1} , 0 )}{{b}_{2}} + {C}_{{r}_{2}} * s + ( 0.5 * ( 1 + p ) * R * ( ( 1 - p ) * R * \frac{{D}_{T}}{{W}_{T}} + 1 ) - p * R ) * \frac{{i}_{y}}{365} ) \qquad ( 7 )$$

Then, the optimal replenishment for a given interest rate can be represented by:

$$R ( {i}_{y} ) = \{ \begin{matrix}\sqrt{\frac{2 * 365 * {W}_{T} ( {C}_{b} * {b}_{2} - {C}_{{r}_{1}} * {b}_{1} + {C}_{{r}_{2}} * {b}_{2} * s )}{( {D}_{T} * {b}_{2} * \text{?} * ( 1 - p ) * ( 1 + p ) )}} & for R \geq {b}_{1} \\ \sqrt{\frac{2 * 365 * {W}_{T} ( {C}_{b} + {C}_{{r}_{2}} * s )}{( {D}_{T} * \text{?} * ( 1 - p ) * ( 1 + p ) )}} & for R < {b}_{1}\end{matrix}$$

$$\text{?} \text{indicates text missing or illegible when filed}$$

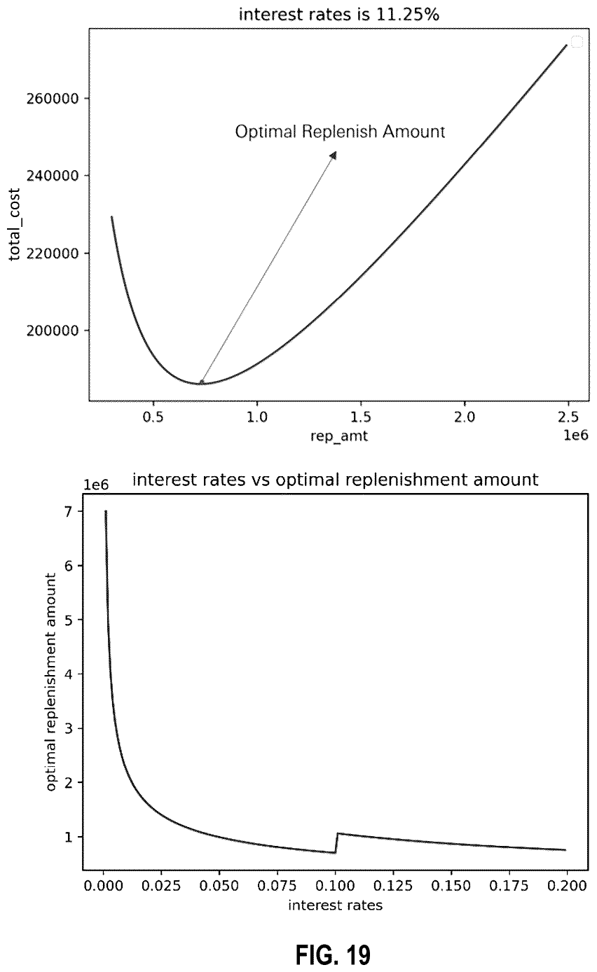

FIG. 19 shows charts mapping the optimal replenishment amount against total cost and interest rates. The objective is to find a value of R that optimizes cash costs with a given i_{y} without significantly affecting cash availability to thereby reduce overall costs. Given an interest rate, the optimal replenishment amount of an individual machine can be determined. FIG. 19 also shows a relationship between optimal replenishment amount and interest rate being that the higher the interest rate, the lower the optimal replenishment amount corresponding to the machine.

The above mathematical models can be illustrated in an example experiment where there are 475 remote ATMs over a time period of approximately 3 months, such as March to mid June, when the annual interest rate is 11.25%.

TABLE 3
displays the experimental results:

| GROUP_ID | NUM_OF_ENTITY | START_DATE | END_DATE | REPLENISHMENT_TIME |
|---|---|---|---|---|
| Origin | 475 | 2023 Mar. 1 | 2023 Jun. 18 | 5821 |
| Optimal_v1 | 475 | 2023 Mar. 1 | 2023 Jun. 18 | 16144 |

| GROUP_ID | CASH_AVAILABILITY | COST_OF_CASH | COST_OF_TRIP | TOTAL_COST |
|---|---|---|---|---|
| Origin | 99.29% | 19,499,975.40 | 10,357,363.30 | 29,857,338.7 |
| Optimal_v1 | 96.80% | 7,740,983.78 | 15,816,649.68 | 23,557,633.5 |

wherein the origin row shows the case under the current setting and the optimal_v1 row saves $370,000 USD but with the cash availability dropping from 99.29% to 96.80%, which is approximately a 3% reduction.

However, in some cases, the optimal R is too small to support a daily demand. The optimal replenishment amount must also consider the number of days the replenishment amount is sufficient to support while improving the cash availability as well. To address this issue, a constraint can be placed on R to create a refined mathematical model:

$${R}_{refined} = max ( R , n * {W}_{DailyUpperLimit} ) \qquad ( 9 )$$

wherein N represents the number of days, W_{DailyUpperLimit} is the upper limit of the daily withdrawals, and R_{refined} is the refined replenishment amount which can support demand for n days.

This refined model can be tested in an example experiment involving a sample 451 remote ATMs over a period of a month with an annual interest rate of 11.25%.

TABLE 4
displays the experimental results as follows:

| GROUP_ID | NUM_OF_ENTITY | START_DATE | END_DATE | REPLENISHMENT_TIME |
|---|---|---|---|---|
| Origin | 451 | 2022 Mar. 1 | 2023 Mar. 31 | 17268 |
| Optimal_2w | 451 | 2022 Mar. 1 | 2023 Mar. 31 | 28591 |
| Optimal_2.5w | 451 | 2022 Mar. 1 | 2023 Mar. 31 | 24567 |
| Optimal_3w | 451 | 2022 Mar. 1 | 2023 Mar. 31 | 21641 |

| GROUP_ID | CASH_AVAILABILITY | COST_OF_CASH | COST_OF_TRIP | TOTAL_COST |
|---|---|---|---|---|
| Origin | 99.62% | 64,332,249 | 29,941,508 | 94,273,757 |
| Optimal_2w | 99.16% | 41,982,103 | 32,433,836 | 74,415,939 |
| Optimal_2.5w | 99.34% | 46,965,300 | 32,433,836 | 79,399,136 |
| Optimal_3w | 99.48% | 51,231,999 | 32,433,836 | 83,665,835 |

As shown in the optimal_2w row, when n=2, the saving is around $1.2M USD with cash availability of 99.16%. In the optimal_2.5_w row, when n=2.5, the saving is around $880,000 USD with cash availability of 99.34%. In the optimal_3w row, when n=3, the saving is around $630,000 USD with cash availability of 99.48%. With increments in the value of n, there is still a large amount of savings with higher cash availabilities, which is an improvement from the original mathematical model.

TABLE 5
displays the experimental results of the refined model extended
to all remote ATM experimental data for one year:

| GROUP_ID | NUM_OF_ENTITY | START_DATE | END_DATE | REPLENISHMENT_TIME |
|---|---|---|---|---|
| Origin | 3271 | 2022 Mar. 1 | 2023 Feb. 28 | 113446 |
| all_remote_2_wd | 3271 | 2022 Mar. 1 | 2023 Feb. 28 | 184042 |
| all_remote_2_5_wd | 3271 | 2022 Mar. 1 | 2023 Feb. 28 | 158094 |
| all_remote_3_wd | 3271 | 2022 Mar. 1 | 2023 Feb. 28 | 143371 |

| GROUP_ID | CASH_AVAILABILITY | COST_OF_CASH | COST_OF_TRIP | TOTAL_COST |
|---|---|---|---|---|
| Origin | 99.43% | 416,663,351 | 189,055,637 | 605,718,988 |
| all_remote_2_wd | 98.90% | 276,566,810 | 229,862,475 | 506,429,285 |
| all_remote_2_5_wd | 99.12% | 303,974,925 | 214,503,980 | 518,478,905 |
| all_remote_3_wd | 99.21% | 324,658,709 | 205,856,600 | 530,515,309 |

In the all_remote_2_wd row, when n=2, the saving is approximately $6M USD with cash availability of 98.9%. In the all_remote_2_5_wd row, when n=2.5, the saving is around $5.2M USD with cash availability of 99.12%. In the all_remote_3_wd row, when n=3, the saving is approximately $4.5M USD with cash availability of 99.21%.

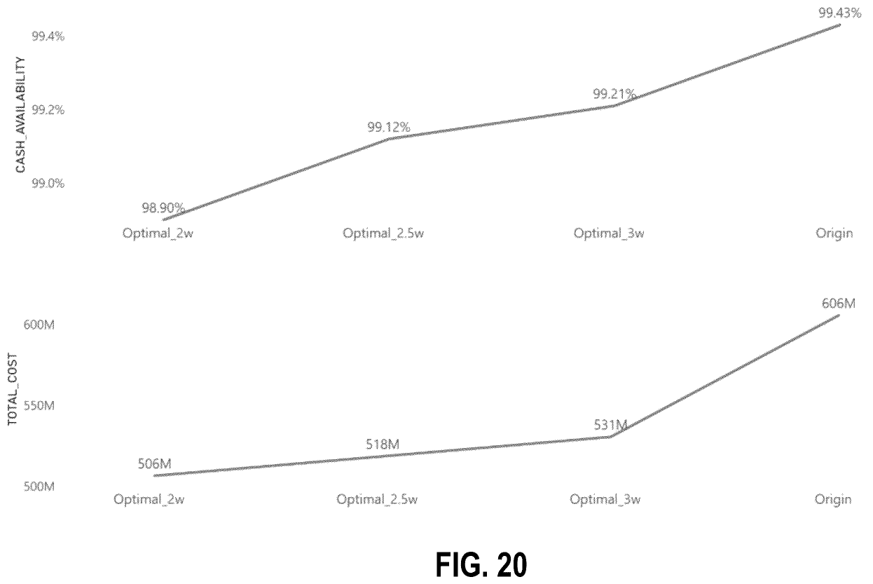

FIG. 20 is a chart displaying the cash availability and total cost in each for when the refined experimental object is expanded to all remote ATM experimental data for one year. According to FIG. 20, the more days that can be supported, the higher the cash availability, which allows users to select a replenishment amount within the range based on their needs.

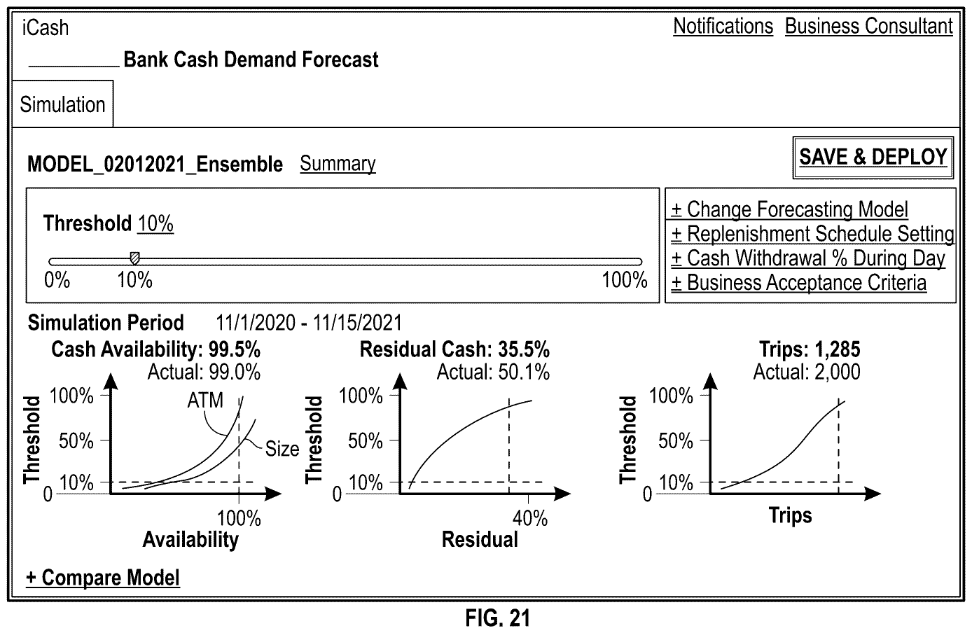

FIG. 21 is an example user interface for a simulation feature enabling users to optimize cash replenishment strategies for the machines.

In some embodiments, the proposed system includes a self-service feature that leverages machine learning-based cash withdrawal predictions to simulate the impact of adjusting key thresholds on performance metrics. Users can experiment with different settings and analyze the results before deploying changes to a production environment.

For example, if the previous trigger threshold was 20% and the base threshold was 50,000, the final threshold would be 60,000. A user can adjust the replenishment trigger threshold to 10%, which will make the final threshold become 55,000, meaning that only when the ATM machine has a balance lower than 55,000 will a cash order be generated.

The simulation feature can help users analyze if there is still room to decrease a machine's cash availability to help save on the cost of trips. Users can initiate a simulation to run for a period of time by selecting a machine and adjusting the threshold to a specific value. As shown in FIG. 21, there is a slider for the user to adjust the threshold value. Once the simulation finishes, the proposed system can compare the simulation results with actual performance statistics for the same period in terms of cash availability, cost of trips, and cost of cash. This comparison will aid the system in determining whether to apply the simulated threshold to a production environment in a next iteration. Providing this simulation feature to users enables the users to interact with the system and self-service to manipulate cash order generations in production by themselves.

An artificial intelligence/machine learning based system is proposed that tracks and analyzes live ATM data that is captured, for example, based on physical sensor inputs and a corpus of data obtained from physical interactions by users with ATMs. The inputs are processed using machine learning algorithms that are adapted to process factors including seasonality, holidays, public events, location, and recent withdrawal trends to accurately predict the amount of cash needed at each ATM. The use of machine learning allows for a more dynamic and responsive cash distribution strategy. The live data feed from ATMs can include physical sensor data, which is then processed to inform the predictive approach by updating a trained machine learning model with current withdrawal patterns.

A specific architecture is proposed that utilizes two models being operated in parallel as an ensemble model approach based on Applicant's testing with physical machines in a practical and applied setting. The ensemble model approach is provided as a physical system that operates two models simultaneously, both models being trained as candidate models. Both models are utilized and trained during inference time separately to optimize a loss function (e.g., MAE performance), and during inference, the model with a superior MAE performance is determined by a run time decision making computer process and used to control ATM replenishment control signal generation. In a practical implementation, the superior MAE performance is based on the models' performance at run time as it is unclear which of the two models will be superior until during inference. This approach does not rely on selecting a model out of the two models ahead of time, and instead, the two models are both deliberately maintained until run time. The two models being used together include a first model, a fully connected neural network data architecture, and a second model, a tree-based learning algorithm provided as a gradient boosting framework (e.g., the Light Gradient-Boosting Machine, also known as the LightGBM). From a practical perspective, the ensemble models can be operated with a prediction buffer configured to allow for specific parameter tuning.

Although unintuitive to use the proposed specific doubled architecture, it is a special combination of the two models that yields a result and a benefit that is more than a sum of its parts. Ensemble models can be used to reduce generalization error of the result by merging predictions of the different models. Using ensemble models not only enhances accuracy but also provides resilience against uncertainties and biases in the data.

In operation, the prediction system can be configured by run periodically (e.g., nightly) to predict a cash deposit and generate a clearing order based on prediction data outputs, and the mini-batch data can be uploaded at a higher frequency (e.g., 15 minutes), and the model prediction and re-training can be used to generate a cash clearing order that can be configured to control one or more cash-in-transit logistics operations. In a variation of the approach, instead of, or in addition to the graphical user interface, the artificial intelligence/machine learning based system is configured to generate machine outputs that directly control and provision cash replenishments of currency cassettes by generating and submitting logistics requests for currency replenishment.

The prediction system can be optimized for different usage and operation, such as to increase a cassette utilization percentage, reducing a total number of clearing trips, and/or reducing outage (and thus increasing service availability). The system can be configured for simultaneous operation against live production data as an automatic monitoring system that is able to run autonomously or semi-autonomously to control replenishment operations predictively.

In some embodiments, the generated replenishment control commands can be generated with entropy to modify path and operational timing by injecting noise to make cash-in-transit operations less vulnerable to physical attack by adding unpredictability. However, this noise injection will also reduce the tracking to optimal replenishment timing. As a physical output, a graphical user interface, such as a dashboard, can be rendered that visualizes live withdrawal patterns, enabling a user to make informed decisions and respond quickly to cash demand. In application, this approach was found to reduce cash replenishment lead times from up to 36 hours down to just 15 minutes.

In some embodiments, there may be a plurality of ATM groups where multiple ATMs at a particular location can be selectively replenished. In each ATM group (e.g., five ATMs) in a same location serving customers exiting an entrance of a stadium. If an ATM is out of physical notes, a user may simply utilize another ATM that has notes. In this variation, every ATM of each ATM is considered to be a member of a group where an outage is only tracked when a total of all of the ATMs in the group has decreased below a threshold of notes or other dispensed physical objects.

The foregoing has outlined the features and technical advantages in order that the detailed description that follows may be better understood. Additional features and advantages will be described hereinafter. It should be appreciated by those skilled in the art that the conception and specific embodiment disclosed may be readily utilized as a basis for modifying or designing other structures. It should also be realized by those skilled in the art that such equivalent constructions do not depart from the spirit and scope of the embodiments described herein. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the embodiments described herein.

An objective of this disclosure is to introduce the machine learning model design, development and implementation for CDM cash deposit prediction to reduce manual efforts and optimize the KPIs in existing CDM operations. In particular, CDM cash clearing orders are generated automatically or semi-automatically to replace prior manual rule-based logic in which the clearing operation is conducted when the ATM in the same site is replenished or when the CDM has not been cleared for a fixed number of days. The manual processes is formulated as an optimization problem for which the technical objective is to decide when a clearing order should be imposed based on the time series prediction of the cash deposit amount in the next days.

As noted herein, in a variation, the approach is to control the replenishment process semi-automatically or automatically based on a combination of physical sensor inputs from a live ATM feed, a coupled machine learning model generating cash cassette refill instructions, and tracked sensor inputs registering the physical replenishment and subsequent user withdrawal activities. The system can thus operate in a feedback loop in as indicated by physical sensor readings, and continually improve the forecasting approach and automatic refilling approach. As noted herein, the system can also be coupled to one or more oracle systems providing a pipeline of datasets relating to third party/environmental data, which can be used in combination with the live ATM physical sensor feed information for running the machine learning model in an inference mode to generate outputs that are used ultimately for generating cash cassette refill instructions.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example.

Those of skill would further appreciate that the various illustrative logical blocks, modules, circuits, and algorithm steps (e.g., the logical blocks in FIGS. 6-7) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a processor, a digital signal processor (DSP), an ASIC), a field programmable gate array (FPGA) or other programmable logic device, discrete gate or transistor logic, discrete hardware components, or combinations thereof designed to perform the functions described herein. A processor may be a microprocessor, but in the alternative, the processor may be another form of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a computer, or a processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus- or step-plus-function limitations, unless such a limitation is explicitly recited in a given claim using the phrase(s) “means for” or “step for,” respectively.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for machine learning-based physical currency cassette replenishment, the system comprising:
a computer processor operating in conjunction with computer memory and a non-transitory computer readable data storage, the computer processor configured to:
instantiate a machine learning data model architecture utilizing an ensemble model including a fully connected neural network framework architecture coupled with a gradient boosting framework architecture that uses a tree-based algorithm following a leaf-wise growth approach;
receive a training dataset obtained from one or more historical datasets, and train the ensemble model using a loss function adapted to minimize a total number of physical cassette refill operations to establish a trained ensemble model;
provide, to the trained ensemble model, an inference dataset based on a pipeline of live ATM sensor feeds;
select one of the fully connected neural network framework architecture and the gradient boosting framework architecture to use for the trained ensemble model during processing and execution of the inference data set;
generate, using the trained ensemble model, one or more prediction data outputs for each ATM coupled to the live ATM sensor feeds;
for each of the one or more prediction data outputs above a threshold, automatically generate one or more data messages controlling a refill or removal operation associated with a corresponding coupled ATM;
confirm one or more refill or removal operations based on physical sensor readings from the live ATM sensor feeds, and
generate an updated inference dataset for continued operation of the trained ensemble model.

2. The system of claim 1, wherein downstream usage of the refilled ATM is utilized for updating the trained ensemble model.

3. The system of claim 1, wherein the fully connected neural network includes a ReLU layer network in combination with a sigmoid layer.

4. The system of claim 2, wherein a reduce-increase-reduce framework is utilized to determine a number of nodes in each layer.

5. The system of claim 1, wherein the gradient boosting framework architecture is a LightGBM model.

6. The system of claim 1, wherein batch normalization and dropout approaches are utilized to control activation functions.

7. The system of claim 1 wherein a mean absolute error (MAE) is utilized as a loss function.

8. The system of claim 1, wherein the data messages controlling a refill or removal operation associated with a corresponding coupled ATM are sequenced based on a generated path for a periodic scheduled cash-in-transit vehicle.

9. The system of claim 1, wherein the corresponding coupled ATM include ATM groupings, where grouped ATMs at a location are considered to be a single ATM.

10. The system of claim 1, wherein the ensemble model utilizes batch normalization and dropout.

11. A method for machine learning-based physical currency cassette replenishment, the method comprising:
instantiating a machine learning data model architecture utilizing an ensemble model including a fully connected neural network framework architecture coupled with a gradient boosting framework architecture that uses a tree-based algorithm following a leaf-wise growth approach;
receiving a training dataset obtained from one or more historical datasets, and train the ensemble model using a loss function adapted to minimize a total number of physical cassette refill operations to establish a trained ensemble model;
providing, to the trained ensemble model, an inference dataset based on a pipeline of live ATM sensor feeds;
generating, using the trained ensemble model, one or more prediction data outputs for each ATM coupled to the live ATM sensor feeds;
for each of the one or more prediction data outputs above a threshold, automatically generating one or more data messages controlling a refill or removal operation associated with a corresponding coupled ATM;
confirming one or more refill or removal operations based on physical sensor readings from the live ATM sensor feeds, and
generating an updated inference dataset for continued operation of the trained ensemble model.

12. The method of claim 11, wherein downstream usage of the refilled ATM is utilized for updating the trained ensemble model.

13. The method of claim 11, wherein the fully connected neural network includes a ReLU layer network in combination with a sigmoid layer.

14. The method of claim 12, wherein a reduce-increase-reduce framework is utilized to determine a number of nodes in each layer.

15. The method of claim 11, wherein the gradient boosting framework architecture is a LightGBM model.

16. The method of claim 11, wherein batch normalization and dropout approaches are utilized to control activation functions.

17. The method of claim 11 wherein a mean absolute error (MAE) is utilized as a loss function.

18. The method of claim 11, wherein the data messages controlling a refill or removal operation associated with a corresponding coupled ATM are sequenced based on a generated path for a periodic scheduled cash-in-transit vehicle.

19. The method of claim 11, wherein the corresponding coupled ATM include ATM groupings, where grouped ATMs at a location are considered to be a single ATM.

20. A non-transitory computer readable medium, storing machine interpretable instructions, which when executed by a processor, cause the processor to perform a method for machine learning-based physical currency cassette replenishment, the method comprising:
instantiating a machine learning data model architecture utilizing an ensemble model including a fully connected neural network framework architecture coupled with a gradient boosting framework architecture that uses a tree-based algorithm following a leaf-wise growth approach;
receiving a training dataset obtained from one or more historical datasets, and train the ensemble model using a loss function adapted to minimize a total number of physical cassette refill operations to establish a trained ensemble model;
providing, to the trained ensemble model, an inference dataset based on a pipeline of live ATM sensor feeds;
generating, using the trained ensemble model, one or more prediction data outputs for each ATM coupled to the live ATM sensor feeds;
for each of the one or more prediction data outputs above a threshold, automatically generating one or more data messages controlling a refill or removal operation associated with a corresponding coupled ATM;
confirming one or more refill or removal operations based on physical sensor readings from the live ATM sensor feeds, and
generating an updated inference dataset for continued operation of the trained ensemble model.
